(19) United States
(12) Patent Application Publication
(10) Pub. No.: US 2008/0232970 A1
(43) Pub. Date: Sep. 25, 2008

(54) Mold Assembly and Method for Injection Molding of an Impeller, and Impeller Formed by Said Method

(75) Inventors: Cony Cheng, Dong-Guan City (CN); Victor Lee, Shian-Yang City (CN)

Correspondence Address: GROSSMAN, TUCKER, PERREAULT & PFLEGER, PLLC, 55 SOUTH COMMERICAL STREET, MANCHESTER, NH, 03101, US

(73) Assignees: DELTA ELECTRONICS COMPONENTS (DONGGUAN) CO., LTD., Dong-Guan City (CN); DELTA ELECTRONICS, INC., Taoyuan Hsien (TW)

(21) Appl. No.: 11/867,980

(22) Filed: Oct. 5, 2007

(30) Foreign Application Priority Data
Mar. 23, 2007 (CN) 200710027267.X

(51) Int. Cl. F01D 5/14; B29C 41/42; B29C 45/38

(52) U.S. Cl. 416/223 R; 264/334; 425/358

(57) ABSTRACT

A mold assembly and a method for injection molding of an impeller, and an impeller formed by the method are provided. The mold assembly comprises a first mold, a central mold, and a second mold. The central mold encircles the first mold, and the second mold matches with the first mold and the central mold to form a mold cavity, complementary in shape to the impeller. The melted plastic material is injected into the aforementioned mold cavity. After the plastic material is cured, the central mold is adapted to enclose the cured plastic material. The cured plastic material is removed from the first mold, and then is removed from the central mold and the second mold to form the impeller. The blade portion of the impeller is radially connected to an edge of a central portion of the impeller. The blade portion has a plurality of blades, equally spaced apart with one another in sequence along the edge. Each of the blades comprises a smooth surface without an ejector pin mark.

This application claims priority to the Chinese Patent Application No. 200710027267.X filed on Mar. 23, 2007, the disclosures of which are incorporated herein by reference in their entirety.

### BACKGROUND OF THE INVENTION

1. Field of the Invention

The present invention relates to a mold assembly, a method for injection molding of an impeller, and an impeller formed by the method. More particularly, the present invention relates to a mold assembly that facilitates mold releasing and avoids both mold damage and blade deformation of the impeller, a method for injection molding using the mold assembly, and an impeller formed by the method.

2. Descriptions of the Related Art

Development of technologies has resulted in increasingly widespread use of a variety of electronic products and mechanical devices. With rapid improvement in their efficiency and performance, the increased amount of heat dissipated by these devices is also becoming a concern. Furthermore, when it is desirable to shrink the size of such devices, a proper heat radiating arrangement needs to be considered for their internal mechanism or circuits to achieve a satisfactory cooling effect, which is especially the case for notebook computers or small projectors. Cooling fans with impellers play an important role in meeting this requirement.

Cooling fans are divided into two categories: axial-flow fans and radial-flow fans (i.e., centrifugal fans). Axial-flow fans are capable of providing sufficient cooling air flow but with low static pressure, and therefore are widely adopted in large devices, such as desktop computers, servers or large video/audio apparatuses. In contrast, due to a limited air flow space, radial-flow fans deliver relatively high static pressure, and therefore are often adopted in small devices, such as small projectors and notebook computers with a flat profile and limited space.

Conventional radial-flow fans, which comprise an enclosure and an impeller, are mostly produced with an injection molding machine. The conventional way to release the mold during the injection molding process for such impellers is to provide a fixed ring at intervals between the blades, with each mold releasing ejector pin acting on the fixed ring. However, the ejector pins are fragile due to their small diameter, and a draft taper needs to be provided in mold portions corresponding to the blades to facilitate mold releasing. This tends to result in non-uniformity and deformation in the blades, thus causing an unbalanced rotation of the final product. Due to this flawed mold assembly design and the sharp edges of its mating inserts, damage often occurs to male molds in the mold assembly, which entails frequent replacement of the molds and inevitably makes cost of the mold assembly high.

In view of the disadvantages of the prior-art impeller mold described above, there exists an urgent need in this field to provide a mold assembly that can simplify the manufacturing of cooling fans to improve the quality of products, thereby reducing the manufacturing cost and eliminating the need for complex manufacturing procedures.

### SUMMARY OF THE INVENTION

One objective of this invention is to provide a mold assembly for injection molding of an impeller. The mold assembly comprises a first mold, a central mold and a second mold, wherein the central mold is configured to encircle the first mold, and the second mold is configured to match with the first mold and the central mold to form a mold cavity that is complementary in shape to the impeller. After a plastic material filled in the mold cavity is cured, the central mold is adapted to at least partially enclose the impeller to separate from the first mold together.

Another objective of this invention is to provide a method for injection molding of an impeller, which comprises the following steps of: configuring a mold assembly as described above, wherein the mold cavity comprises a central portion and a blade portion which is radially connected to an edge of the central portion; injecting a melted plastic material into the central portion through a plurality of pouring holes; removing the central mold from the first mold after the plastic material is cured and at least partially is enclosed in the central mold; and forming the impeller by removing the cured plastic material from the central mold and the second mold.

Yet a further objective of this invention is to provide an impeller formed by the method described above. The impeller comprises a central portion and a blade portion which is radially connected to an edge of the central portion. The blade portion has a plurality of blades equally spaced apart with one another in sequence along the edge, wherein each of the blades comprises a smooth surface without an ejector pin mark.

Through use of the mold assembly and method of this invention, impeller components can be manufactured in an effective and simple way with reduced production costs, without the need for complex manufacturing procedures, thereby attaining the goal to simplify production.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic cross-sectional view of a mold assembly in accordance with the preferred embodiment of this invention;

FIG. 2A is a schematic view of a first exploded action in an injection molding method of this invention;

FIG. 2B is a schematic view of an exploded action subsequent to that shown in FIG. 2A;

FIG. 2C is a schematic view of an exploded action subsequent to that shown in FIG. 2B;

FIG. 2D is a schematic view of an exploded action subsequent to that shown in FIG. 2C; and

FIG. 3 is a schematic view of an impeller formed in accordance with the method of this invention.

### DESCRIPTION OF THE PREFERRED EMBODIMENT

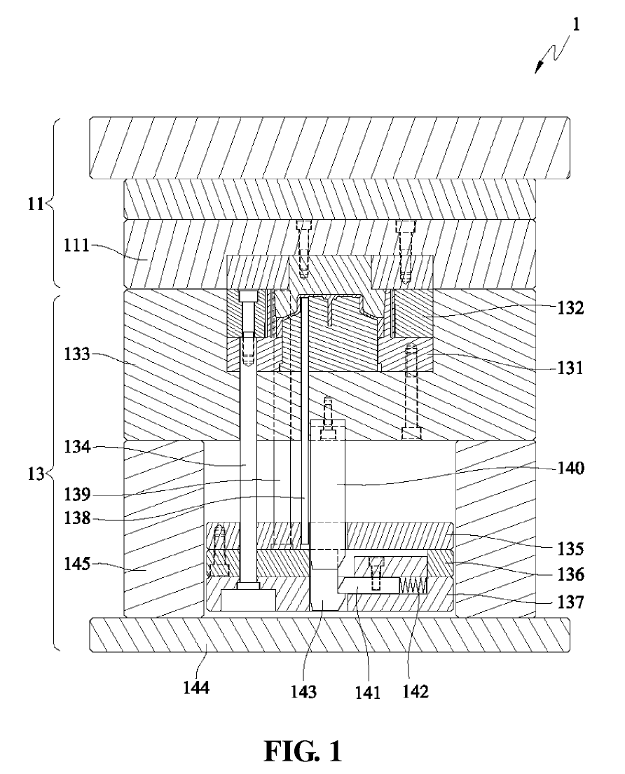

FIG. 1 depicts a mold assembly 1 for injection molding of an impeller of this invention, which comprises a fixed mold 11 and a movable mold 13. The movable mold 13 further comprises a first mold 131, a central mold 132, a movable mold plate 133, an ejector rod 134, a fixed plate 135, a cushion plate 136, an ejector plate 137, an ejector pin 138, a return rod 139, an ejector post 140, a sliding plate 141, a spring 142, a hook 143, a bottom plate 144 and a supporting plate 145. The fixed mold 11 further comprises a second mold 111. The first mold 131 is a male mold, while the central mold 132 and the second mold 111 are both female molds. The central mold 132 of the movable mold 13 is configured to encircle the first mold 131, and the second mold 111 of the fixed mold 11 is configured to match with the first mold 131 and the central mold 132 to form a mold cavity that is complementary in shape to the impeller, all of which constitutes the mold assembly 1 for injection molding of the impeller.

To assemble the mold assembly 1, the first mold 131 and the central mold 132 are placed into the movable mold plate 133 of the movable mold 13, and the first mold 131 is fixed to the movable mold plate 133. One end of the ejector rod 134 pushes against a bottom surface of the central mold 132, while the other end is fixed to the ejector plate 137 through holes in the fixed plate 135 and the cushion plate 136. The ejector pin 138 and the return rod 139 both have one end fixed to the fixed plate 135, and have their other ends disposed in corresponding ejector pin hole and return rod hole respectively in the moving plate 133 and the first mold 131. The fixed plate 135 is fixed to the cushion plate 136. The ejector post 140 has one end fixed to the movable mold plate 133, and has a wedge angle at the other end that corresponds to a wedge end of the sliding plate 141. The motion of the sliding plate 141 is restricted within a sliding channel in the ejector plate 137, and the spring 142 is disposed between the slide way of the ejector plate 137 and the sliding plate 141. The upper end of the hook 143 is fixed to the fixed plate 135. The lower end with a wedge angle also corresponds to the wedge angle of the sliding plate 141. The hook 143 is configured to move alternately with the ejector post 140, and the fixed plate 135, the cushion plate 136 and the ejector plate 137 are stacked within a cavity of the supporting plate 145, where the movable mold plate 144 is fixed to the supporting plate 145.

A method for injection molding of the impeller using the mold assembly 1 is also provided in this invention, which is utilized in conjunction with an injection molding machine to realize automation of the impeller production. In this method, the mold assembly 1 as described above is first configured so that the mold cavity comprises a central portion and a blade portion which is radially connected to an edge of the central portion. Melted plastic material is then injected into the central portion through a plurality of pouring holes.

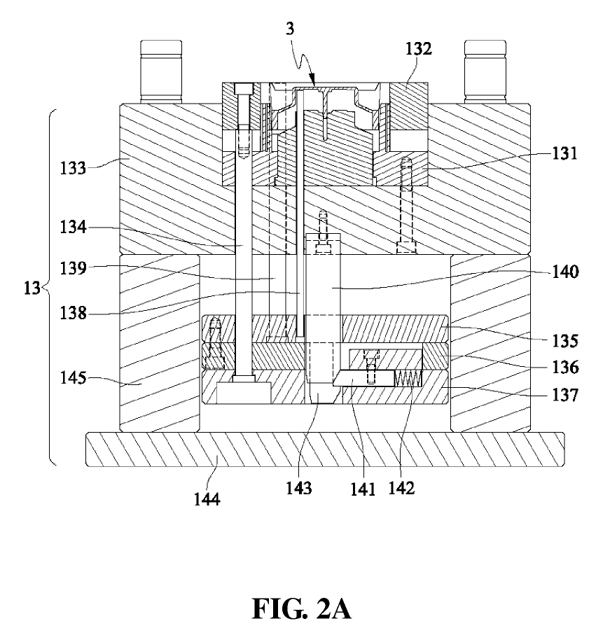

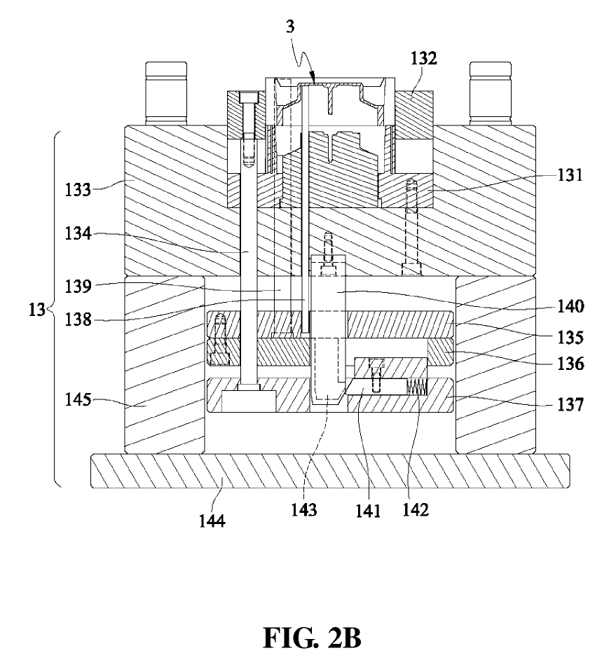

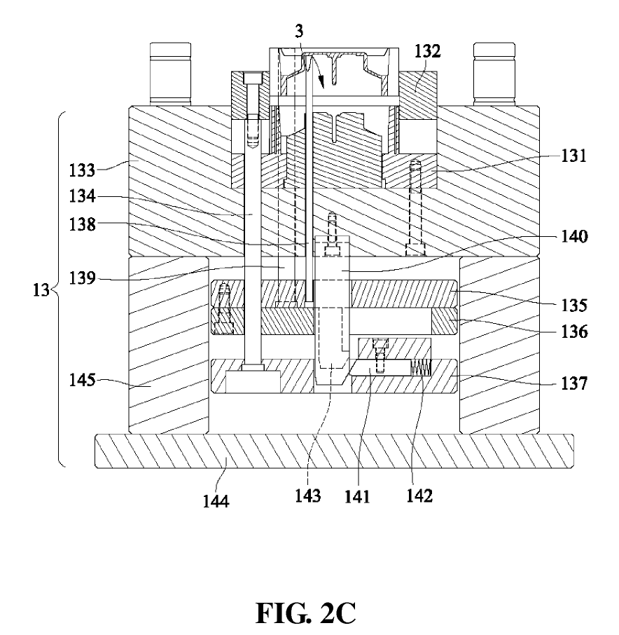

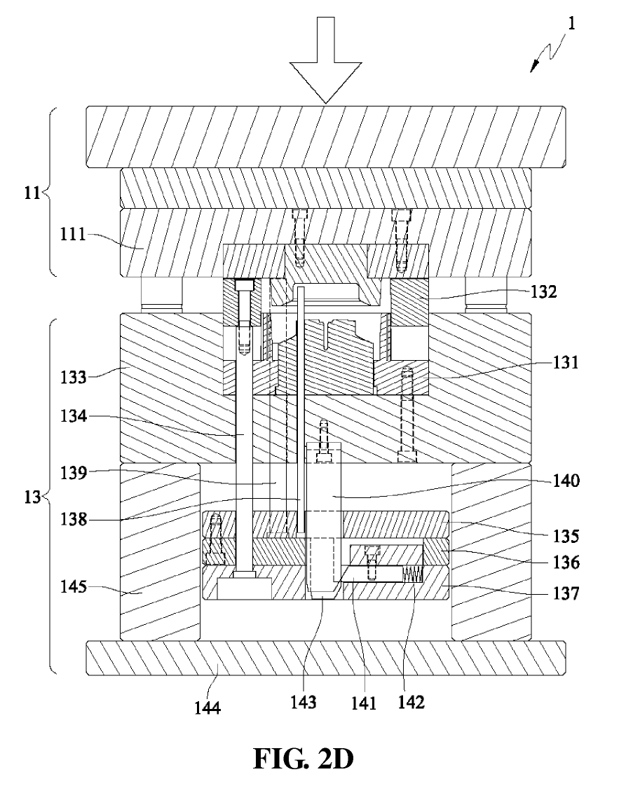

After the plastic material filled in the mold cavity is cured (i.e., the impeller is formed in the mold cavity), the central mold 132 is adapted to at least partially enclose the cured plastic. At this time, the injection molding machine applies an ejector force to the hook 143 to hook the sliding plate 141, thereby having the ejector plate 137, the cushion plate 136 and the fixed plate 135 move with it. Meanwhile, the ejector rod 134 pushes against the central mold 132 to eject and separate the impeller from the first mold 131, as depicted in FIG. 2A.

The next step is to remove the cured plastic from the second mold 111 and the central mold 132 in sequence. To accomplish this, the central mold 132 is first separated from the second mold 111, and then the cured plastic is ejected out of the central mold 132 by at least one ejector pin 138 acting at the central position of the central mold 132. The detailed actions are as follows: Once the sliding plate 141 contacts the ejector post 140, the force applied by the ejector post 140 will overcome the spring force and compress the spring 142, thereby detaching the sliding plate 141 from the hook 143, as depicted in FIG. 2B. Then, the ejector plate 137, the ejector post 140, and the central mold 132 stop moving, while the cushion plate 136, the fixed plate 135 and the ejector pin 138 continue to move until the impeller is ejected out of the mold assembly completely by the ejector pin 138, as depicted in FIG. 2C. When the mold assembly needs to be returned to the molding position for closing the mold, the fixed mold 11 pushes the return rod 139 back. The sliding plate 141 begins to compress the spring 142 under the action of the wedge angle of the hook 143 until it returns to be engaged by the hook 143 in preparation for the next working cycle, as depicted in FIG. 2D.

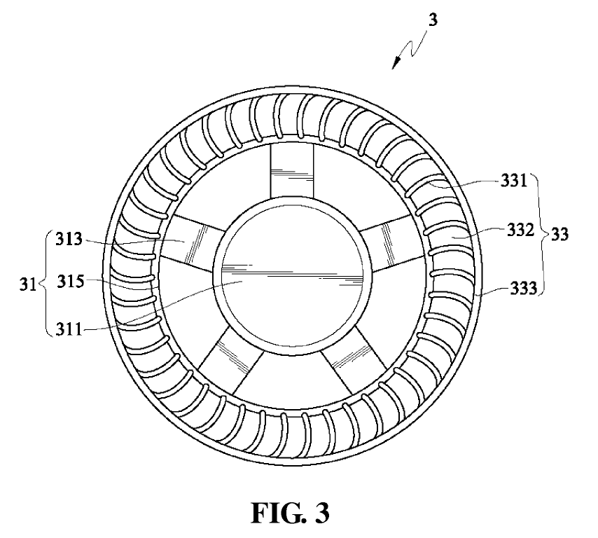

FIG. 3 depicts the top view of an impeller produced with the method described above. The impeller 3 comprises a central portion 31 and a blade portion 33, and is made of a plastic material (but this invention is not limited thereto). The central portion comprises a central base portion 311, a plurality of inner brackets 313 and an edge 315, while the blade portion 33 comprises a plurality of blades 331 of arc shape (which is often the case in the centrifugal type radial-flow impellers) and a fixed ring 333. The blade portion 33 is radially connected to the edge of the central portion 31, with the plurality of blades 331 equally spaced apart with one another in sequence along the edge. The plurality of blades 331 are fixed together through the fixed ring 333 at either ends or at the middle of the blades, with a surface called a fixed connecting surface 332 that is formed at the fixed intervals between the blades.

In the conventional injection mold, an ejector pin is needed at each fixed interval between the blades to push the impeller out, causing ejector pin marks on the fixed connecting surface of the fixed ring. In contrast, the injection mold of this invention will not leave ejector pin marks on the fixed connecting surface, thereby resulting in a smooth surface without ejector pin marks on the fixed connecting surface of the fixed ring.

It follows from the embodiments described above that, the injection molding architecture proposed in this invention for manufacturing an impeller is advantageous for mold releasing of cylindrical impellers, and thus can reduce the number of pouring holes in the injection mold for producing plastic impeller to three or less, thereby reducing waste of raw material. In addition, this invention ejects the impeller through the use of a combination of the central mold and an ejector pin, thus eliminating the need of multiple thin individual ejector pins. In the injection molding assembly of this invention, since the central mold is adapted to enclose the final products during the release of the mold, a draft taper is no longer needed at the male mold (the first mold) portions corresponding the blades, resulting in a substantial increase of uniformity of blade thickness compared to the result of the conventional mold assembly, further enhancing the stability of the blades during rotation.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mold assembly for injection molding of an impeller, comprising:
a first mold;
a central mold, configured to encircle the first mold; and
a second mold, configured to match with the first mold and the central mold to form a mold cavity, complementary in shape to the impeller;
wherein after plastic material filled in the mold cavity is cured, the central mold is adapted to at least partially enclose the cured plastic material.

2. The mold assembly as claimed in claim 1, wherein the impeller is adapted to uniformly remove from the central mold.

3. The mold assembly as claimed in claim 1, wherein the first mold is a male mold, and each of the central mold and the second mold is a female mold.

4. A method for injection molding of an impeller, comprising:
configuring a mold assembly as claimed in claim 1, wherein the mold cavity comprises a central portion and a blade portion, which is radially connected to an edge of the central portion;
injecting melted plastic material into the central portion through a plurality of pouring holes;
removing the central mold from the first mold after the plastic material is cured and at least partially is enclosed in the central mold; and
forming the impeller by removing the cured plastic material from the central mold and the second mold.

5. The method as claimed in claim 4, wherein the step of forming the impeller comprises the step of adopting at least one ejector pin to push the cured plastic material out of a position of the central mold relative to the central portion.

6. The method as claimed in claim 5, wherein the step of forming the impeller is to remove the central mold and the second mold before pushing the cured plastic material out by the at least one ejector pin.

7. An impeller, formed by using the method as claimed in claim 4, the impeller comprising:
a central portion; and
a blade portion, radially connected to an edge of the central portion, the blade portion having a plurality of blades, equally spaced apart with one another in sequence along the edge;
wherein each of the blades comprises a smooth surface without an ejector pin mark.
